(19) United States
(12) Patent Application Publication
(10) Pub. No.: US 2025/0335916 A1
(43) Pub. Date: Oct. 30, 2025

(54) Detecting Fraudulent Optical Tone Transactions Received by Client Using Spiking Neural Network and Quantum Sensors

(71) Applicant: Bank of America Corporation, Charlotte, NC (US)

(72) Inventors: George Albero, Charlotte, NC (US); Naga Vamsi Krishna Akkapeddi, Charlotte, NC (US)

(21) Appl. No.: 18/645,766

(22) Filed: Apr. 25, 2024

(51) Int. Cl. G06Q 20/40; G06Q 20/38; H04L 9/08

(52) U.S. Cl. CPC G06Q 20/4014; G06Q 20/38215; G06Q 20/3829; H04L 9/0852

(57) ABSTRACT

Systems and methods secure transactions using optical tones, which are audio or visual signals encoded with transactional data, combined with advanced security measures. It employs Quantum encryption to initially secure the optical tones at creation, ensuring their integrity and confidentiality. During a transaction, spiking neural networks (SNNs) process these encrypted tones, filtering out irrelevant or harmful data and authenticating the content. Concurrently, Quantum sensors analyze the electromagnetic properties of the tones, such as frequency and pitch, to detect any signs of tampering or forgery. If discrepancies are found, the transaction is halted to prevent fraud. This invention also supports dynamic security management, allowing for on-demand updates to encryption parameters and the generation of new tones as needed. Additionally, for higher-value transactions, multiple tones may be required, enhancing the security framework. This invention offers a robust solution to secure optical tone-based financial transactions against advanced fraudulent activities.

### TECHNICAL FIELD

The present disclosure relates to the field of information security, focusing on the enhancement of security protocols within digital payment systems through advanced cryptographic and neural network technologies. Specifically, the invention leverages the integration of Quantum encryption and spiking neural networks (SNNs) to secure and authenticate optical tones used in financial transactions.

### DESCRIPTION OF THE RELATED ART

Customers and clients can receive payments through various methods. Reports have indicated that clients receive Zelle payments via email or text, which requires action on their part, such as accepting the payment. Currently, there is no solution in place to detect fraud associated with these transactions. This issue is compounded when payment transactions occur using optical tones, where there are limited or no options available for systems to automatically validate both the sender and the receiver to ensure a secure and clean transaction.

In the realm of digital transactions, the proliferation of innovative payment methods has been paralleled by an increase in the sophistication of fraudulent activities. Among these, one notable vulnerability has emerged with the growing use of optical tones in payment systems. Optical tones, which carry encoded data through audio or visual signals, have become a target for fraudulent schemes due to their inherent security challenges. This vulnerability stems largely from the difficulty in authenticating the source and integrity of the optical tones used in transactions.

Traditionally, optical tones are used to convey sensitive transaction information between devices and financial institutions. As such, they must be rigorously secured to prevent unauthorized access and misuse. However, the current systems in place often fall short in this respect. The lack of robust mechanisms to verify the authenticity of these tones before processing payments leaves a gaping hole in transaction security. This vulnerability can lead to significant financial losses and erosion of trust among consumers and financial institutions alike.

The challenge is compounded by the rapid evolution of technology and the increasing creativity of fraudsters who target the smallest security gaps. With each advancement in payment technology, malicious actors find new ways to intercept or replicate optical tones, manipulating transactions to their advantage. This issue is exacerbated by the global nature of digital transactions, where a single compromised element can affect systems worldwide, multiplying the potential for damage exponentially.

Furthermore, the methods currently available to validate optical tones are either too slow, disrupting the flow of transactions, or insufficiently secure, failing to detect sophisticated frauds. This leads to a paradoxical situation where increasing security measures can either hinder the user experience by slowing down transactions or compromise security by not being thorough enough, neither of which is desirable in today's fast-paced economic environment.

Moreover, as the digital economy grows, the volume of transactions using optical tones is increasing, placing an even greater burden on existing validation systems. These systems must scale not only in terms of processing capacity but also in their ability to adapt to new types of fraud that evolve as quickly as the measures designed to thwart them. Current solutions are often static and struggle to adapt to new threats, creating a continuous process of attempting to catch-up with fraudsters.

The need for a solution is clear, yet developing one is complex due to the technical challenges involved. Ensuring the security of optical tones requires an intricate balance between speed, accuracy, and the capacity to learn from new fraudulent patterns. Any effective solution must seamlessly integrate with existing financial technologies, ensuring that upgrading security does not necessitate a complete overhaul of current systems.

The financial industry's struggle with securing optical tone-based transactions is not merely a matter of preventing individual losses but is crucial for maintaining the overall health of the digital economy. Confidence in digital payment systems is foundational to the continued growth and stability of global markets. As such, securing these systems is not only a technical requirement but a central economic imperative.

The current situation is thus marked by a critical gap between the capabilities of fraudsters and the defensive measures available to institutions and individuals using optical tone-based transactions. This gap represents not just a technical challenge but a significant risk to the integrity and reliability of modern financial systems.

This gap has long been recognized by stakeholders in the financial sector, yet effective solutions have been elusive. The industry has been in dire need of a robust, adaptable, and forward-looking solution that can secure optical tone transactions against both current and future threats. This need is both long-felt and unmet, representing a critical vulnerability in the digital transaction space that continues to challenge financial security worldwide.

### SUMMARY OF THE INVENTION

The invention presents a revolutionary approach to securing financial transactions through the utilization of spiking neural networks (SNNs) and Quantum sensors, specifically targeting the security challenges associated with optical tone-based payment systems. Optical tones, which include both audio and/or visual data formats, are increasingly used in digital transactions as a medium for transferring encoded financial information between parties. The core innovation of this invention lies in its ability to enhance the security of these transactions by introducing a method to authenticate and validate these tones using advanced Quantum technology and neural networks.

Quantum computing encryption is used to secure the optical tones generated by payment senders. This encryption ensures that the data contained within the tones is protected against unauthorized interception and manipulation, providing a robust layer of security from the point of creation. The encrypted tones are then stored securely, awaiting further processing during transaction initiation.

When a transaction is initiated, the sender transmits their Quantum-encrypted optical tone to the financial institution or payment gateway. Upon receipt, this tone must undergo a series of validations to ensure its authenticity and integrity. SNNs process the optical tones, filtering out any irrelevant or potentially malicious data that could compromise the transaction. By focusing on the essential elements of the tone, the SNNs serve as a checkpoint, ensuring that only clean and verified data progresses through the transaction pipeline.

In parallel to the SNNs' processing, Quantum sensors are employed to analyze the electromagnetic signals of the optical tones. These sensors are capable of detecting minute variations in frequency and pitch that might indicate tampering or fraud. By comparing these properties to the expected characteristics stored during the encryption process, the sensors can validate the sender's identity and the tone's authenticity with high precision.

Once the optical tones have been sanitized by the SNNs and validated by the Quantum sensors, a comparison is made between the tone sent by the sender and the tone previously stored by the receiver. This step ensures that the tones match and conform to the agreed-upon protocols and encryption standards. If the tones are confirmed to match, the transaction proceeds; if not, it is halted to prevent potential fraud.

An additional layer of security is provided by the financial institutions' ability to initiate ad-hoc requests for new optical tones. This feature allows for dynamic updates to the encryption parameters and tone characteristics, which can be adjusted based on evolving security needs or in response to detected threats. This flexibility ensures that the security measures are not static but evolve continuously to counter new and emerging fraud tactics.

The invention also incorporates a feature where multiple tones can be required for higher-value transactions. This method increases security by requiring additional verification steps, thereby reducing the risk of significant financial fraud. Each tone involved in such transactions would undergo the same rigorous process of encryption, storage, processing by SNNs, and validation by Quantum sensors, ensuring a multi-faceted defense strategy.

Moreover, the implementation of this system does not overly burden the user experience. The generation and transmission of optical tones are designed to be seamless and integrated smoothly with existing financial applications and interfaces. Users can generate and transmit these tones using their regular financial apps, with the added security measures operating transparently in the background.

In summary, this invention provides a comprehensive solution to the security challenges faced in optical tone-based financial transactions. By leveraging cutting-edge technologies such as Quantum encryption, spiking neural networks, and Quantum sensors, the invention offers a multi-layered security framework that is both robust and adaptable. This approach not only enhances the security of digital transactions but also builds trust among users by ensuring that their financial transactions are protected against the most sophisticated fraud threats.

The potential impact of this invention on the financial industry is significant, as it addresses a critical and growing need for enhanced transaction security. As digital transactions continue to grow in volume and complexity, the technologies developed in this invention provide essential tools for ensuring these transactions are conducted safely and securely, thereby supporting the continued growth and stability of the digital economy.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a method for securing financial transactions uses encoded optical tones processed by spiking neural networks (SNNs) and validated by Quantum sensors. This method includes capturing an optical tone from a user device, where the tone contains data representing a user's transactional intent or identity encoded within audio or visual signals. The method further includes encrypting the captured optical tone at the user device using Quantum encryption techniques that leverage principles of Quantum mechanics in Quantum computing to generate encryption keys, thereby securing the data within the optical tone against unauthorized interception and manipulation. Additionally, the encrypted optical tone is securely stored in a database linked to the user's profile, ensuring the tone is retrievable for future transaction verification. The encrypted optical tone is then transmitted to a financial institution or payment gateway, where its authenticity is validated using Quantum sensors that analyze electromagnetic properties such as frequency and pitch to detect alterations indicating tampering or cloning. The method also involves processing the validated optical tone through spiking neural networks configured to filter out irrelevant or potentially malicious data, focusing solely on isolating essential data pertinent to the transaction. The processed optical tone is compared at the payment gateway with a reference tone previously stored and associated with the user's profile to verify a match in both transactional data and electromagnetic characteristics. Finally, the transaction is authorized based on positive outcomes of the validation and comparison, thereby ensuring the integrity and security of the transaction.

In some arrangements, the capturing of the optical tone is initiated by a trigger mechanism within the user device, activated based on one or more of the following conditions: an on-demand request by the user, a predetermined time interval, and/or a system-generated requirement for a unique optical tone for each transaction to enhance security.

In some arrangements, the method further includes applying a noise filtering algorithm to the captured optical tone to remove any extraneous background noise or disturbances that could affect the integrity of the data before the encryption step.

In some arrangements, the Quantum encryption of the optical tone includes applying a layer of Quantum-resistant encryption algorithms designed to transform the optical tone into a form that is computationally infeasible to reverse without the corresponding Quantum decryption key.

In some arrangements, the method further includes re-encrypting the optical tone using updated Quantum encryption parameters each time the optical tone is retrieved for a transaction to respond to evolving security threats and maintain robust data protection.

In some arrangements, the dynamic security measures include generating and distributing new optical tones at predetermined intervals or in response to detection of a security breach, with each new tone replacing the previous tone for future transactions to continuously enhance security.

In some arrangements, the Quantum sensors perform a detailed analysis of the optical tone by comparing the current electromagnetic signals to those of the stored reference signals, using precise measurements of deviations in frequency and pitch to identify and reject tampered or forged tones.

In some arrangements, the spiking neural networks are additionally configured to integrate and process biometric data that is associated with the user and linked to the optical tone, thereby using physical or behavioral characteristics or the like to further authenticate the transaction.

In some arrangements, for transactions involving monetary values exceeding a predetermined threshold, multiple optical tones are required, each undergoing the encryption, storage, validation, and processing steps independently to provide a layered and enhanced security approach.

In some arrangements, the method includes real-time monitoring and adaptation of security measures based on continuous risk assessment analyses, allowing for immediate implementation of enhanced security protocols in response to detected threats or attempted security breaches.

In some arrangements, a system for securing financial transactions uses encoded optical tones, comprising a user device configured to capture optical tones containing transactional data encoded within audio or visual signals. A Quantum encryption module integrated into the user device encrypts the captured optical tones using encryption keys generated through Quantum mechanics principles, thereby securing the transactional data against unauthorized access. The system also includes a secure storage database linked to user profiles where the encrypted optical tones are stored and retrievable for transaction verification. A communication interface is configured to transmit the encrypted optical tones to a financial institution or payment gateway. At the payment gateway, Quantum sensors are located to validate the authenticity of received optical tones by analyzing their electromagnetic properties, including frequency and pitch, to detect tampering or cloning. Spiking neural network processors at the payment gateway process the validated optical tones by filtering out irrelevant and potentially malicious data, isolating essential transactional data. A comparison engine at the payment gateway is designed to compare the processed optical tones with reference tones stored in the secure storage database, verifying a match in transactional data and electromagnetic characteristics. Finally, a transaction authorization module at the payment gateway is configured to authorize the transaction based on positive validation and comparison results, ensuring the integrity and security of the transaction.

In some arrangements, the user device includes a trigger mechanism that initiates the capturing of optical tones based on one or more of the following conditions: an on-demand request by the user, a predetermined time interval, or a system-generated requirement for a unique optical tone for each transaction to enhance security.

In some arrangements, the user device further comprises a noise filtering module configured to apply an algorithm to remove extraneous background noise or disturbances from the captured optical tones before they are encrypted by the Quantum encryption module.

In some arrangements, the Quantum encryption module is further configured to apply a layer of Quantum-resistant encryption algorithms designed to transform the optical tones into a form that is computationally infeasible to decrypt without the corresponding Quantum decryption key.

In some arrangements, the secure storage database includes functionality for re-encrypting the optical tones using updated Quantum encryption parameters each time an optical tone is retrieved for a transaction in response to evolving security threats.

In some arrangements, the system includes a dynamic security management module configured to generate and distribute new optical tones at predetermined intervals or in response to detection of a security breach, with each new tone replacing the previous tone for future transactions.

In some arrangements, the Quantum sensors are further configured to perform detailed analyses by comparing the current electromagnetic signals of the optical tones to previously stored signals, using measurements of deviations in frequency and pitch to identify and reject tampered or forged tones.

In some arrangements, the spiking neural network processors are further configured to integrate and process biometric data associated with the user and linked to the optical tones, using physical or behavioral characteristics to further authenticate the transaction.

In some arrangements, the system further includes a high-value transaction module configured to require multiple optical tones for transactions exceeding a predetermined monetary threshold, with each tone undergoing independent encryption, storage, validation, and processing to provide a layered security approach.

In some arrangements, a method for securing optical tone-based financial transactions using spiking neural networks (SNNs) and Quantum sensors comprises capturing an optical tone representing a transactional intent or user identity. The method includes encrypting the captured optical tone using Quantum encryption to secure data within the optical tone and storing the encrypted optical tone in a secured manner linked to a user profile. The method also involves validating the authenticity of the encrypted optical tone using Quantum sensors to detect alterations in electromagnetic properties, processing the optical tone with spiking neural networks to filter out irrelevant information and isolate essential transactional data, and comparing the processed optical tone with a previously stored tone to ensure consistency and match in transactional data and electromagnetic properties. Finally, the financial transaction is authorized based on the validation and comparison results.

The following description and the appended claims, with reference to the accompanying drawings, which all form a part of this specification and where like reference numerals designate corresponding parts in the various figures, will make these and other features and characteristics of the current technology, as well as the methods of operation and functions of the related elements of structure and the combination of parts and economies of manufacture, more apparent. As computer-executable instructions (or as computer modules or in other computer constructs) recorded on computer-readable media, one or more of the different procedures or processes described herein may be implemented in whole or in part. Steps and functionality might be carried out on a single machine or dispersed over several devices that are connected to one another. However, it is clearly recognized that the drawings are meant primarily for descriptive and illustrative purposes and are not meant to define the boundaries of the invention. Unless the context makes it obvious otherwise, the single forms of “a,” “an,” and “the” as they appear in the specification and claims include plural referents.

### BRIEF DESCRIPTION OF DRAWINGS

FIG. 1 depicts comprehensive security framework designed to handle transactions using optical tones, a method that integrates advanced encryption, Quantum computing, and neural network technologies to enhance the security and integrity of financial transactions.

FIG. 2 depicts a sample process flow for securing optical tones as potentially utilized in accordance with one or more aspects of this disclosure and illustrates exemplary steps from the initial capture of audio, image, or video input, through various stages of processing like noise filtering, machine language processing, and encryption, culminating in the generation of a visual representation of the encrypted optical tone, such as embedded in a potential QR code.

FIG. 3 depicts sample setup, creation, and secure storage of optical tones in accordance with one or more aspects of this invention.

FIG. 4 depicts a sample process flow for detecting fraudulent optical tone payments, received by clients, utilizing spiking neural networks (SNNs) and Quantum sensors in accordance with one or more aspects of this disclosure.

FIG. 5 outlines a sample class diagram for a comprehensive system designed to secure optical tone-based financial transactions, featuring classes for capturing, encrypting, transmitting, and validating optical tones using advanced technologies like Quantum encryption and spiking neural networks, utilizing components such as: a user device, encryption module, communication interface, sensing and neural network processors, a secure storage database, and modules for transaction authorization, dynamic security management, and module for handling high-value transactions.

### DETAILED DESCRIPTION

At a high level, the invention introduces a sophisticated system and method designed to enhance the security of digital transactions using optical tones, which are audio and/or visual signals encoded with transactional data. It integrates Quantum encryption and spiking neural networks (SNNs) to secure and validate these tones, ensuring that each transaction is authenticated and protected from unauthorized access and fraudulent activities.

Quantum encryption is utilized at the initiation of the transaction process, where optical tones created by the sender are encrypted to safeguard the data they carry. This step maintains the confidentiality and integrity of the data from the point of creation to its final destination. Once these encrypted tones are transmitted for a transaction, they are processed by SNNs. These networks are adept at analyzing complex data patterns and are used here to scrutinize the incoming optical tones, filtering out any irrelevant or potentially harmful data that could compromise the transaction.

In parallel, Quantum sensors are employed to further inspect the optical tones. These sensors are capable of detecting subtle variations in the properties of the tones, such as frequency and pitch, which are indicative of tampering or forgery. This dual approach of using both SNNs and Quantum sensors ensures a robust validation process that verifies the authenticity of the tones before the transaction proceeds.

If the properties of the optical tones match the expected parameters, the transaction is allowed to continue. Otherwise, it is halted to prevent any fraudulent activity. This system also allows financial institutions to request additional tones or updates to the encryption parameters dynamically, enhancing the security measures as needed based on ongoing assessments of threat levels.

Furthermore, for transactions that involve larger values, the system may require multiple optical tones to provide a layered security approach, necessitating multiple validations that increase the transaction's security level.

Overall, the invention provides a dynamic, secure, and adaptable framework for handling digital transactions that significantly enhances the security measures available for transactions using optical tones. By incorporating cutting-edge technologies such as Quantum encryption, spiking neural networks, and Quantum sensors, the system addresses the pressing need for secure and reliable transaction methods in the digital era.

The following account of various example embodiments is designed to fulfill the objectives mentioned earlier, with reference to the accompanying illustrations that are relevant to this disclosure. These illustrations demonstrate multiple systems and methods for implementing the disclosed information. It is important to acknowledge that there are alternative implementations possible, and adjustments to both structure and functionality can be applied. The description outlines various links between elements, which are to be interpreted broadly. Unless specified otherwise, these connections can be either direct or indirect, and may be established through wired or wireless means. This document does not intend to limit the nature of these connections.

Terms like “computers,” “machines,” and similar phrases are interchangeably used herein, depending on the context, to refer to devices that can be general-purpose or specialized, designed for particular functions, either virtual or physical, or capable of connecting to networks. This includes all relevant hardware, software, and components familiar to those with expertise in the area. Such devices may be outfitted with specialized circuits like application-specific integrated circuits (ASICs), microprocessors, cores, or other processing units to execute, access, control, or implement various types of software, instructions, data, modules, processes, or routines as mentioned. The usage of these terms in the text is not intended to be limiting or exclusive to any specific kinds of electronic devices or components and should be interpreted in the widest sense by those with relevant expertise. Specific details on computer/software components, machines, etc., are not provided for the sake of brevity and under the assumption that such information is within the realm of understanding of skilled professionals in the domain.

Software, executable code, data, modules, procedures, and similar components can be housed on tangible, computer-readable physical storage devices. This encompasses everything from local memory and network-attached storage to diverse forms of memory that are accessible, whether they are removable, remote, cloud-based, or available via other channels. These components can be saved on both volatile and non-volatile memory and might operate under various conditions, including autonomously, upon request, according to a predetermined schedule, spontaneously, proactively, or in response to specific triggers. They can be stored together or distributed among several computers or devices, incorporating their memory and other parts. Moreover, these components can be housed or disseminated across network-accessible storage systems, within distributed databases, big data frameworks, blockchains, or distributed ledger technologies, either collectively or through distributed arrangements.

The phrase “networks” or similar terms refer to a broad range of communication systems, such as local area networks (LANs), wide area networks (WANs), the Internet, cloud-based networks, and both wired and wireless networks. This category also includes specialized networks like digital subscriber line (DSL) networks, frame relay networks, asynchronous transfer mode (ATM) networks, and virtual private networks (VPN), which may be interconnected in various ways. Networks are designed with specific interfaces to support different types of communications—internal, external, and managerial—with the capability to allocate virtual IP addresses (VIPs) to these interfaces as necessary. The architecture of a network is built upon an array of hardware and software elements. This includes, but is not limited to, access points, network adapters, buses, both wired and wireless ethernet adapters, firewalls, hubs, modems, routers, and switches, which may be positioned within the network, on its periphery, or outside. Software and executable instructions work on these components to enable network operations. Additionally, networks support HTTPS and a variety of other communication protocols, making them suitable for packet-based data transmission and communication.

As used herein, Generative Artificial Intelligence (AI) or the like refers to AI techniques that learn from a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models-Meta LLAMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in the field of biology and medicine. (5) NVIDIA AI Models-Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in the field of generative AI. One or more of the foregoing may be used herein as desired. All are considered to be within the sphere and scope of this disclosure.

Generative AI and LLMs can be used in various aspects of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and utilizing large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

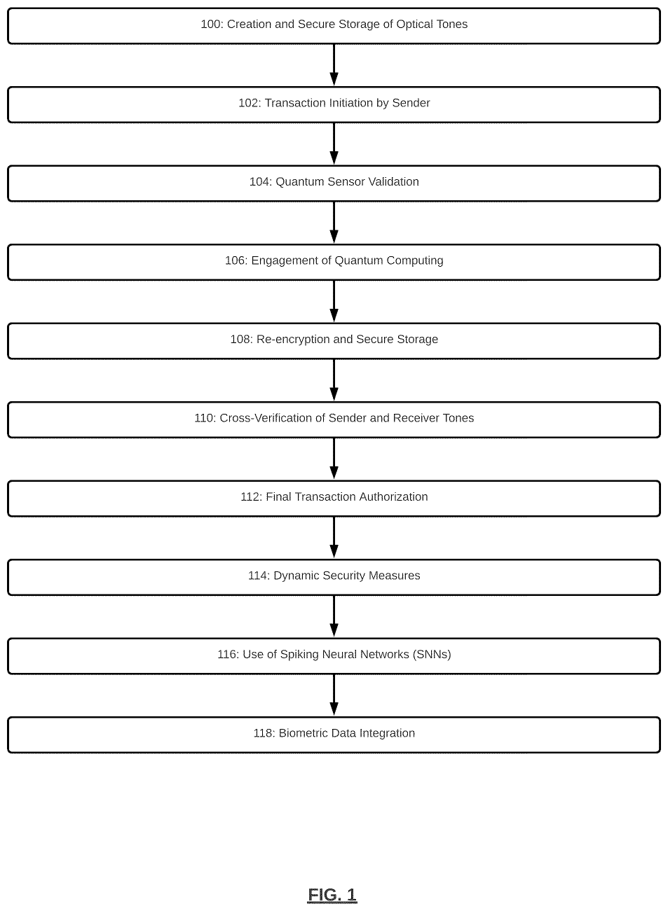

By way of non-limiting disclosure, FIG. 1 outlines a comprehensive security framework designed to handle transactions using optical tones, a method that integrates advanced encryption, Quantum computing, and neural network technologies to enhance the security and integrity of financial transactions.

Creation and Secure Storage of Optical Tones (100): At the foundation of the process, each payment receiver generates unique optical tones for different senders. These tones are then securely encrypted using Quantum encryption, which leverages the principles of Quantum mechanics to provide a level of security that is fundamentally resistant to hacking. Each tone is stored against the client's profile, ensuring that it can be referenced in future transactions for validation purposes.

Transaction Initiation by Sender (102): When a sender initiates a transaction, they employ an optical tone that represents their identity or transactional intent. This tone is sent to a payment gateway, often accompanied by a payment token, which acts as an additional layer of transactional information and security.

Quantum Sensor Validation (104): Upon receiving the optical tone, the payment gateway utilizes Quantum sensors to validate the tone's authenticity. These sensors are highly sensitive to the electromagnetic properties of the tone, such as its pitch and frequency, and can detect any alterations that might indicate tampering or cloning attempts. This step confirms that the tone is both genuine and untampered.

Engagement of Quantum Computing (106): The payment gateway then employs Quantum computing to retrieve the original optical tone directly from the sender's encrypted profile. Quantum computing provides the capability to perform complex computations at unprecedented speeds, which is essential for real-time transaction processing in a secure environment.

Re-encryption and Secure Storage (108): Once the optical tone is verified, it is re-encrypted and stored back in the sender's profile. This re-encryption every time the tone is used ensures that any data used in the transaction remains secure against future security threats.

Cross-Verification of Sender and Receiver Tones (110): To further enhance security, the payment gateway compares the retrieved optical tone from the sender with the tone stored by the receiver. This comparison involves analyzing the tones for matching characteristics using Quantum sensors, ensuring that both parties in the transaction are using valid and synchronized tones.

Final Transaction Authorization (112): If the optical tones and any associated payment tokens match and pass all security checks, the transaction is authorized to proceed. If any mismatch or anomaly is detected, the transaction is stopped immediately, preventing potential fraudulent activity.

Dynamic Security Measures (114): Recognizing the dynamic nature of security threats, the system allows for the on-demand generation and distribution of new optical tones at predetermined frequencies. This capability ensures that the security measures can evolve in response to emerging threats, maintaining a robust defense against fraud.

Use of Spiking Neural Networks (116): Throughout the transaction process, SNNs are employed to filter out irrelevant information from the optical tones. These networks are designed to mimic the way information is processed biologically, allowing them to efficiently identify and isolate the essential data from the optical tones. This helps in reducing noise and focusing on the data critical to validating the transaction.

Biometric Data Integration (118): In addition to transactional data, the SNNs can also process biometric data linked to the optical tones. This integration of biometric data adds an extra layer of security by tying the transaction to the physical identity of the sender or receiver, making unauthorized transactions significantly more difficult.

This process highlights a sophisticated, multi-layered approach to transaction security, integrating cutting-edge technologies to provide a secure, efficient, and reliable framework for handling financial transactions using optical tones. This ensures that each step, from tone generation to final transaction authorization, is secured against potential threats, safeguarding the interests of all parties involved in the transaction.

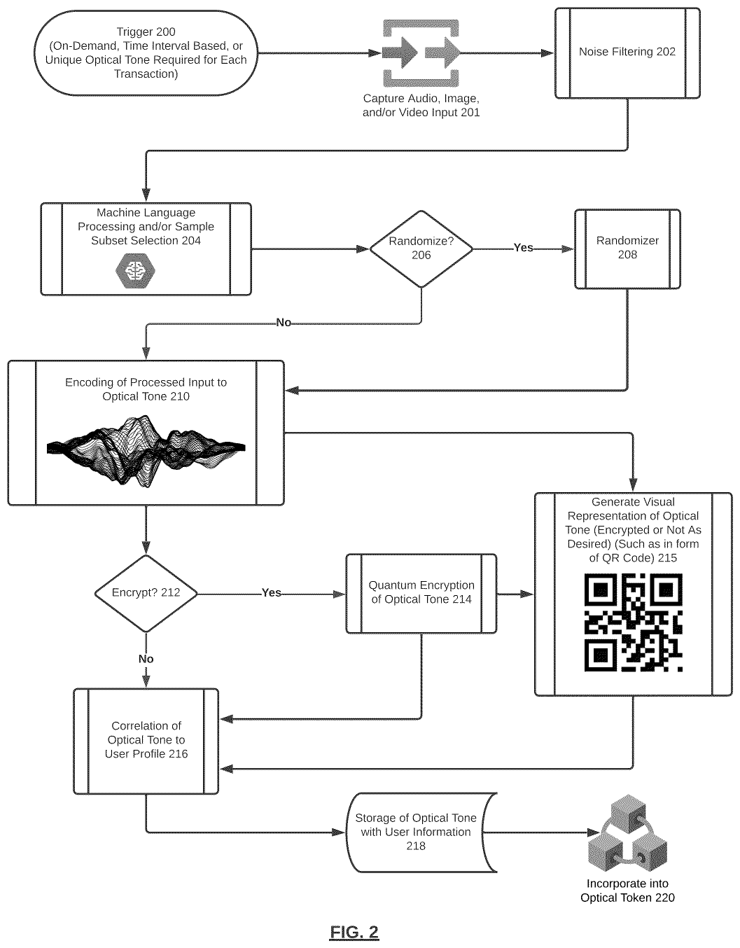

By way of non-limiting disclosure, FIG. 2, illustrates a process flow diagram that details the steps involved in capturing, processing, and securing user inputs to generate an optical tone, which is then utilized in transactions. This diagram details a sequence of operations that include various technological implementations to enhance security and efficiency.

Starting the process, Trigger (200) initiates the sequence, which could be activated on-demand, at a specific time interval, or under a condition that a unique optical tone is required for each transaction. This flexibility allows for dynamic response based on the system's requirements and user interaction.

Next, Capture Audio, Image, and/or Video Input (201) represents the first step in collecting input data. This could include a variety of media such as audio clips, photographs, or videos, which are essential components for creating a user profile or for transaction authentication.

The captured inputs are then passed through Noise Filtering (202) where any irrelevant or extraneous background noises or visual disturbances are removed. This ensures that only pertinent data is processed, increasing the accuracy and reliability of subsequent steps.

Following noise filtering, Machine Language Processing and/or Sample Subset Selection (204) is applied. This step involves advanced machine learning algorithms to analyze and select relevant pieces of the input data for further processing. This could entail identifying key features or frames from video, critical snippets from audio, or significant elements from images. This can be utilized to appropriately size the optical tone to a standardize number of bytes of information and/or data structure.

A decision point, Randomize (206), then determines whether the selected data subset should undergo a randomization process. If “Yes,” the data moves to Randomizer [208], which applies a random transformation to the data, enhancing security by making the output less predictable and more resistant to tampering or unauthorized decryption.

Following randomization, another decision point Encrypt (212) asks whether the data should be encrypted. If affirmative, the data proceeds to Quantum Encryption of Optical Tone (214), which applies Quantum cryptography techniques to ensure that the data is secured with cutting-edge encryption technology, vastly increasing the difficulty for unauthorized parties to decrypt the information. The use of Quantum computing enables large blocks of data to be processed and encrypted/decrypted quickly.

Encoding of Processed Input to Optical Tone (210) follows, where the selected and possibly randomized and encrypted input data is encoded into an optical tone. This encoding transforms the data into a visual or optical format such as a QR code, making it suitable for easy scanning and recognition by digital devices.

In Generate Visual Representation of Optical Tone (215), the encoded data is formatted into a visually recognizable form, typically a QR code. This visual representation can be encrypted or not, depending on the previous encryption decision, and is ready for use in transactions or further processing.

Correlation of Optical Tone to User Profile (216) links the newly created optical tone to the user's profile. This correlation can personalize the tone to the user's identity, ensuring that the optical tone can be authenticated and traced back to the correct user profile during transactions.

Storage of Optical Tone with User Information (218) involves securely storing the optical tone alongside relevant user information, ensuring that it is available for future transactions and can be quickly accessed and verified against user authentication requests.

Finally, Incorporate into Optical Token (220) completes the process, where the optical tone is integrated into an optical token. This token can then be used as a secure digital credential for authorizing transactions, encapsulating all the processed and secured data into a convenient and secure format ready for transactional use.

Overall, FIG. 2 provides a detailed roadmap of sample steps required to securely capture, process, and utilize user inputs to create highly secure optical tones for transactions, employing advanced technologies like machine learning, randomization, and Quantum encryption to enhance security and user-specific customization.

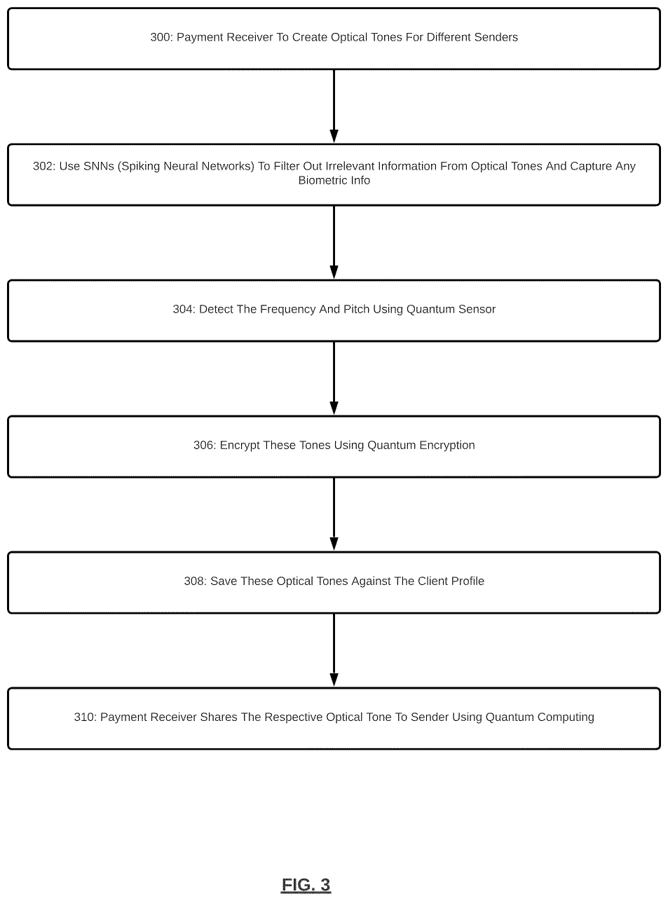

By way of non-limiting disclosure, FIG. 3 depicts sample setup, creation, and secure storage of optical tones in accordance with one or more aspects of this invention.

More specifically, it illustrates the sequence of steps involved in securing optical tones for financial transactions. The process begins with the payment receiver creating unique optical tones for different senders, as indicated in step 300. This initial creation of optical tones ensures that each transaction is associated with a specific, identifiable sender, enhancing the security and traceability of transactions.

Following the creation of the optical tones, step 302 involves the use of Spiking Neural Networks (SNNs) to filter out any irrelevant information from the optical tones and to capture any pertinent biometric information. This step ensures that the optical tones are not only stripped of unnecessary data that could clutter or compromise the transaction process but are also enhanced with biometric data that can provide an additional layer of security.

In step 304, the process incorporates the use of a Quantum sensor to detect the frequency and pitch of the optical tones. This detection is key to validating the authenticity of the tones, as any deviation from the expected frequency and pitch could indicate tampering or fraud.

Once the optical tones have been validated for their authenticity, step 306 involves encrypting these tones using Quantum encryption techniques. Quantum encryption is known for its high security, as it leverages the principles of Quantum mechanics to create encryption keys that are extremely difficult to decrypt without authorization due to the necessity of tremendous computational resources and time requirements.

Step 308 involves saving these Quantum encrypted optical tones against the client profile. This ensures that each tone is securely stored and associated with the correct client, thereby maintaining a secure and accessible record of all optical tones created and used.

Finally, in step 310, the payment receiver shares the respective optical tone with the sender using Quantum computing. This sharing is performed securely and efficiently, leveraging the computational power of Quantum computing to ensure that the transfer of the optical tone to the sender is both swift and secure.

This detailed flow diagram illustrates a robust process designed to enhance the security of financial transactions using optical tones, incorporating advanced technologies such as SNNs, Quantum sensors, and Quantum encryption to ensure that each step from creation to sharing of optical tones is secure and reliable.

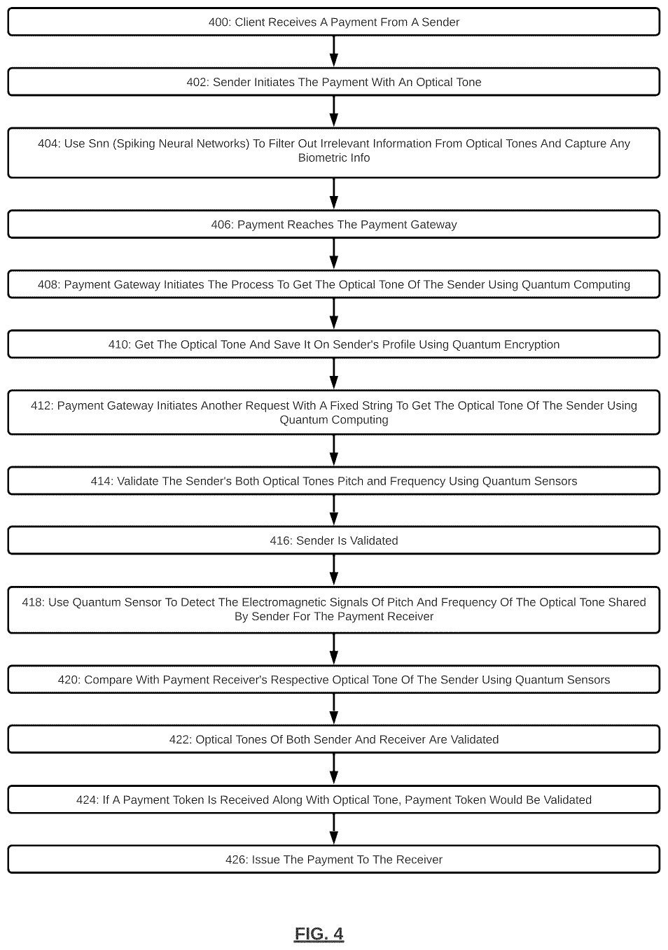

By way of non-limiting disclosure, FIG. 4 provides a comprehensive depiction of the steps involved in processing and securing a financial transaction using optical tones. The steps collectively ensure the authenticity and safety of the transaction from the moment it begins to its completion.

The transaction initiation occurs when a client receives a payment intent from a sender, detailed in step 400. This is the catalyst for the entire sequence of security checks and validations that follow. Immediately after receiving the payment intent, the sender actively engages by transmitting an optical tone, as shown in step 402. This tone contains the encoded transaction data necessary to proceed.

Upon transmission, the optical tone undergoes a rigorous evaluation process beginning with step 404, where Spiking Neural Networks (SNNs) analyze the data. These networks filter out any irrelevant or non-essential information and focus on capturing biometric data embedded within the tone. This step is not only about streamlining the data but also about enhancing the security measures by integrating unique biometric identifiers that are difficult to replicate.

As the filtered and enriched optical tone reaches the payment gateway in step 406, it signifies the gateway's role as a pivotal checkpoint in the transaction process. Here, advanced Quantum computing techniques are employed in step 408 to retrieve and validate the optical tone stored in the sender's profile. This step ensures that the data received matches the data sent, maintaining the transaction's integrity.

In step 410, the tone is then securely saved back onto the sender's profile, re-encrypted using Quantum encryption to protect it against potential future threats. This ensures that any data used in the transaction remains secure, even beyond the current transaction.

The process of validation is extensive, with the payment gateway performing another retrieval of the optical tone in step 412 using a predefined protocol to ensure the tone's consistency and reliability. The Quantum sensors play a role in steps 414 and 418, where they meticulously validate the pitch and frequency of the optical tones involved in the transaction. This dual validation checks for any discrepancies that might indicate tampering or fraud.

Step 420 involves a direct comparison between the optical tone from the sender and a corresponding tone on the receiver's side, using Quantum sensors to ensure perfect synchronization between what was sent and what was expected. This comparison is essential for the transaction's final authorization.

The verification of additional security elements, such as payment tokens in step 424, integrates another layer of security, ensuring that all components of the transaction are validated before final processing.

The transaction concludes in step 426 with the issuance of payment to the receiver, but only after every aspect of the transaction, from the biometric data to the encrypted tones, has been thoroughly verified and validated. This comprehensive approach ensures the highest level of security and integrity, safeguarding both parties involved in the transaction against the sophisticated fraud prevalent in today's digital transaction landscape.

Thus, FIG. 4 illustrates not just a transaction process but a robust security framework that leverages cutting-edge technology to protect and secure financial transactions at every step, ensuring trust and reliability in digital financial environments.

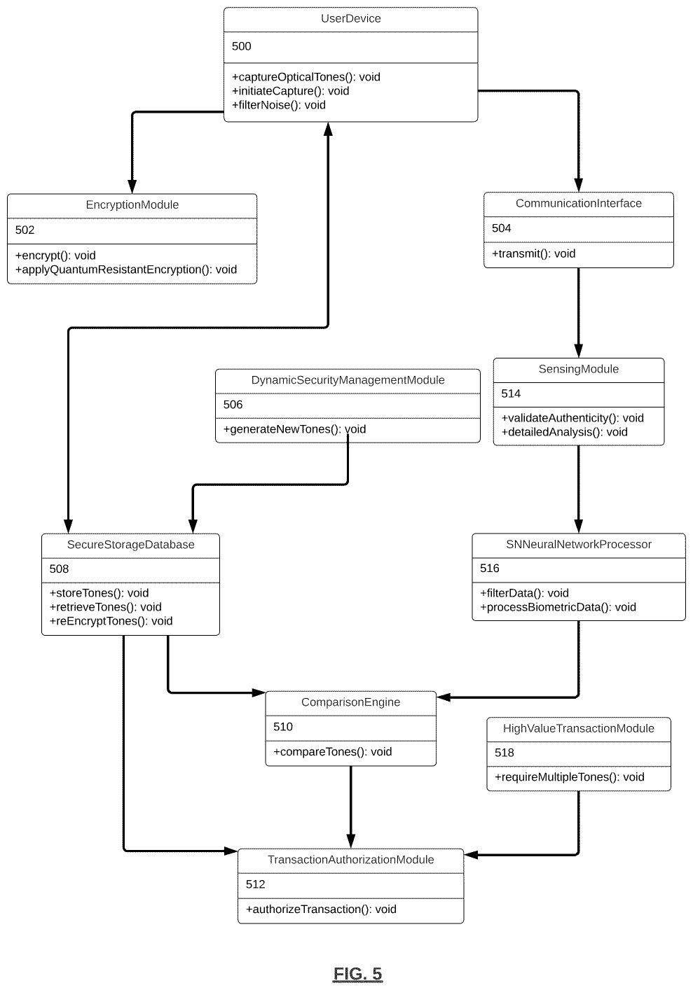

By way of non-limiting disclosure, FIG. 5 depicts a sample class diagram for a system designed to secure financial transactions using optical tones encoded with transactional data, processed by spiking neural networks (SNNs), and validated by Quantum sensors. Each class is designed to work in concert with others, forming a comprehensive, secure transactional system that leverages state-of-the-art technologies in Quantum encryption and neural network processing.

The User Device (class 500) is utilized for the initial stages of the transaction process. It is equipped with methods to capture optical tones (captureOpticalTones( )) which involve recording audio or visual signals that contain encoded transactional data. The device also includes a functionality to initiate the capture of these tones (initiateCapture( )), which can be triggered under various conditions such as on-demand by the user, at scheduled intervals, or based on specific transaction requirements. Additionally, the User Device features a noise filtering capability (filterNoise( )) to ensure the purity and clarity of the captured optical tones before they undergo further processing.

The Encryption Module (class 502) works in conjunction with the User Device and can be internally integrated or externally accessible. It is responsible for the security of the data at the point of capture. This module applies Quantum-resistant encryption algorithms (applyQuantumResistantEncryption( )) to the optical tones, transforming them into a secure format that is highly resistant to unauthorized decryption, thereby enhancing the overall security of the transmitted data.

The Communication Interface (class 504) serves as the conduit for transmitting encrypted optical tones from the User Device to the financial institution or payment gateway. This interface ensures that the transmission of sensitive data is conducted securely and efficiently, maintaining the integrity of the encrypted data throughout the transmission process.

Upon reaching the payment gateway, the optical tones are first handled by the Sensing Module (class 514), which employs Quantum sensors to validate the authenticity of the received tones. This module not only checks for general authenticity (validateAuthenticity( )) but also performs a detailed analysis (detailedAnalysis( )) of the electromagnetic properties of the tones, such as frequency and pitch, to detect any signs of tampering or forgery.

The SNNeural Network Processor (class 516) further processes the validated tones by filtering out irrelevant or potentially malicious data (filterData( )) and integrating biometric data (processBiometricData( )) associated with the user. This integration of biometric data provides an additional layer of security by linking the transaction to the physical identity of the user, making unauthorized transactions significantly more difficult.

The Secure Storage Database (class 508) securely stores the encrypted tones and is capable of retrieving them for transaction verification (retrieveTones( )). This database is also equipped with functionality to re-encrypt the tones (reEncryptTones( )) using updated Quantum encryption parameters whenever they are retrieved, ensuring that the security of stored data evolves in response to new threats.

The Comparison Engine (class 510) compares the processed tones from the SNNeural Network Processor with the reference tones stored in the Secure Storage Database. This comparison (compareTones( )) ensures that the processed and stored tones match in both transactional data and electromagnetic characteristics, which is essential for the transaction's integrity and security.

The Transaction Authorization Module (class 512) is responsible for the final decision-making process in the transaction cycle. This module authorizes the transaction (authorizeTransaction( )) based on the positive outcomes of the validation and comparison processes, ensuring that only legitimate and verified transactions are processed.

For transactions involving higher monetary values, the High Value Transaction Module (class 518) requires that multiple optical tones be used (requireMultipleTones( )). Each tone undergoes the same rigorous process of encryption, storage, validation, and processing, providing a layered and enhanced security approach for high-value transactions.

Lastly, the Dynamic Security Management Module (class 506) enhances the system's adaptability by generating and distributing new optical tones at predetermined intervals or in response to detected security breaches (generateNewTones( )). This module ensures that the security measures are not static but evolve continuously to counter new and emerging fraud tactics.

This detailed class diagram and its corresponding methods outline a sample, sophisticated, multi-layered approach to transaction security, integrating cutting-edge technologies to ensure the secure and reliable handling of financial transactions using optical tones. Each component and its methods are intricately linked to provide a seamless and robust defense against potential security threats.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for securing financial transactions using encoded optical tones processed by spiking neural networks (SNNs) and validated by Quantum sensors, the method comprising the steps of:
capturing an optical tone from a user device, where the optical tone contains data representing transactional intent and user identity encoded within audio and visual signals;
encrypting the optical tone that is captured at the user device using Quantum encryption techniques that employ principles of Quantum mechanics to generate encryption keys, thereby securing the data within the optical tone against unauthorized interception and manipulation;
securely storing the optical tone as encrypted in a database linked to a user profile, ensuring the optical tone that is encrypted is retrievable for future transaction verification;
transmitting the optical tone as encrypted to a payment gateway;
validating authenticity of the optical tone transmitted to the payment gateway using said Quantum sensors that analyze electromagnetic properties including frequency and pitch, detecting alterations indicative of tampering and cloning;
processing the optical tone as validated through spiking neural networks configured to filter out irrelevant as well as potentially malicious data, focusing solely on isolating essential data pertinent to a transaction;
comparing the optical tone as processed at the payment gateway with a reference tone previously stored and associated with the user profile to verify a match in both transactional data and electromagnetic characteristics; and
authorizing the transaction based on positive outcomes of validation and comparison, thereby ensuring integrity and security of the transaction.

2. The method of claim 1, wherein the capturing of the optical tone is initiated by a trigger mechanism within the user device, said mechanism activated based on one or more of the following conditions: an on-demand user request, a pre-determined time interval, or a system-generated requirement for a unique optical tone for each transaction to enhance security.

3. The method of claim 2, further comprising the step of applying a noise filtering algorithm to the optical tone that was captured to remove any extraneous background noise and disturbances that could affect data integrity of before said encrypting.

4. The method of claim 3, wherein encrypting the optical tone includes applying a layer of Quantum-resistant encryption algorithms to transform the optical tone into a form that is computationally infeasible to reverse without a corresponding Quantum decryption key.

5. The method of claim 4, further comprising the step of re-encrypting the optical tone using updated Quantum encryption parameters each time the optical tone is retrieved for a new transaction to respond to evolving security threats and maintain robust data protection.

6. The method of claim 5, further comprising the steps of generating and distributing new optical tones at predetermined intervals or in response to detection of a security breach, with each of said new optical tones replacing a previous tone for future transactions to enhance security.

7. The method of claim 6, wherein the Quantum sensors perform a detailed analysis of the optical tone by comparing electromagnetic signals to those of stored reference signals, using precise measurements of deviations in frequency and pitch to identify and reject tampered tones.

8. The method of claim 7, wherein the spiking neural networks are configured to integrate and process biometric data that is associated with the user and linked to the optical tone, thereby using behavioral characteristics to further authenticate the transaction.

9. The method of claim 8, wherein for transactions involving monetary values exceeding a predetermined threshold, multiple optical tones are required, each undergoing the encryption, storage, validation, and processing steps independently to provide a layered and enhanced security approach.

10. The method of claim 9, wherein the method includes real-time monitoring and adaptation of security measures based on continuous risk assessment analyses, allowing for immediate implementation of enhanced security protocols in response to detected threats.

11. A system for securing financial transactions using encoded optical tones, comprising:
a user device configured to capture optical tones containing transactional data encoded within audio and visual signals;
a Quantum encryption module integrated into the user device, designed to encrypt the optical tones that are captured using encryption keys generated through Quantum mechanics principles, thereby securing the transactional data against unauthorized access;
a secure storage database linked to user profiles, wherein the optical tones that are encrypted are stored and retrievable for transaction verification;
a communication interface configured to transmit the optical tones as encrypted to a payment gateway;
Quantum sensors located at the payment gateway, configured to validate the authenticity of the optical tones received from the communication interface by analyzing their electromagnetic properties, including frequency and pitch, to detect tampering;
spiking neural network processors at the payment gateway, configured to process the optical tones that are validated by filtering out irrelevant and potentially malicious data, and isolating essential transactional data;
a comparison engine at the payment gateway designed to compare the optical tones as processed with reference tones stored in the secure storage database, to verify a match in transactional data and electromagnetic characteristics; and
a transaction authorization module at the payment gateway, configured to authorize a transaction based on positive validation and comparison results, ensuring the integrity and security of the transaction.

12. The system of claim 11, wherein the user device includes a trigger mechanism that initiates the capturing of the optical tones based on one or more of the following conditions: an on-demand user request, a predetermined time interval, or a system-generated requirement for a unique optical tone for each said transaction to enhance security.

13. The system of claim 12, wherein the user device further comprises a noise filtering module configured to apply an algorithm to remove extraneous background noise and disturbances from the optical tones as captured before they are encrypted by the Quantum encryption module.

14. The system of claim 13, wherein the Quantum encryption module is further configured to apply a layer of Quantum-resistant encryption algorithms, designed to transform the optical tones into a form that is computationally infeasible to decrypt without a corresponding Quantum decryption key.

15. The system of claim 14, wherein the secure storage database includes functionality for re-encrypting the optical tones using updated Quantum encryption parameters each time an optical tone is retrieved for a new transaction, in response to evolving security threats.

16. The system of claim 15, wherein the system includes a dynamic security management module configured to generate and distribute new optical tones at predetermined intervals or in response to detection of a security breach, with said new optical tones replacing, for future transactions, previous optical tones.

17. The system of claim 16, wherein the Quantum sensors are further configured to perform detailed analyses by comparing current electromagnetic signals of the optical tones to previously stored signals, using measurements of deviations in frequency and pitch to identify and reject tampered tones.

18. The system of claim 17, wherein the spiking neural network processors are further configured to integrate and process biometric data associated with the user and linked to the optical tones, using behavioral characteristics to further authenticate the transaction.

19. The system of claim 18, wherein the system further includes a high-value transaction module configured to require multiple optical tones for transactions exceeding a predetermined monetary threshold, with said multiple optical tones each undergoing independent encryption, storage, validation, and processing to provide a layered security approach.

20. A method for securing optical tone-based financial transactions using spiking neural networks (SNNs) and Quantum sensors, the method comprising the steps of:
capturing an optical tone representing a transactional intent and user identity;
encrypting the captured optical tone using Quantum encryption to secure data within the optical tone;
storing the optical tone as encrypted in a secured manner linked to a user profile;
validating the authenticity of the encrypted optical tone using Quantum sensors to detect alterations in electromagnetic properties;
processing the optical tone with spiking neural networks to filter out irrelevant information and isolate essential transactional data;
comparing the optical tone as processed with a previously stored tone to ensure consistency and match in transactional data and electromagnetic properties; and
authorizing a financial transaction corresponding to the optical tone based on the validation and comparison results.
